(19) United States
(12) Patent Application Publication
(10) Pub. No.: US 2006/0194024 A1
(43) Pub. Date: Aug. 31, 2006

(54) Decorative pattern and production method therefor

(75) Inventor: Hiroo Nakayama, Hirosaki-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: TEFCO AOMORI CO., LTD., Hirosaki-shi (JP)

(21) Appl. No.: 11/137,235

(22) Filed: May 25, 2005

(30) Foreign Application Priority Data
Feb. 28, 2005 (JP) 2005-052865

(51) Int. Cl. B32B 3/00

(52) U.S. Cl. 428/172; 428/195.1

(57) ABSTRACT

When it is intended that a hologram foil is adhered to a metal pattern, a general-purpose hot-melt adhesive is inferior in an adhesion property to a metal surface and, accordingly, fixing of the hologram foil itself is difficult and, even when such fixing is achieved, a problem of peeling-off, dropping-off or the like of the hologram foil is generated. These problems are solved by forming a primer layer on a surface of the metal pattern and, thereafter, a metal foil having a design such as a hologram foil is fixed through a hot-melt adhesive.

### BACKGROUND OF THE INVENTION

1. Field of the Invention

The present invention relates to decorative patterns which are used, for example, in product logos and decorative components, and methods for producing the decorative patterns. In particular, the present invention relates to a decorative pattern, having a stereoscopic effect and capable of contributing to an enhancement of decorativeness, prevention of forgery and the like, in which a hologram foil or the like is fixed on a surface of a minute metal pattern, and a method for producing the decorative pattern.

2. Background Art

In producing a metallic product having a fine complicated shape such as a product logo or a decorative component, for example, electrodeposition pattern forming methods as described in JP-A Nos. 7-331479, 8-27597 and the like are adopted. In recent years, in the product logo and the like, a further enhancement of decorativeness is required; for example, it is required that a fine design is formed on a surface of the electroformed (electrodeposited) pattern. However, in the methods as described in the above-described patent documents, it is not described that the design is formed on the surface of the electroformed pattern.

In Patent Document 1 (JP-A No. 2001-342595), an electroformed pattern having a design and a production method thereof are described. The method comprises the steps of: transferring a surface design of an article having a design onto an electrically conductive thin film; and forming an electroformed pattern on the design surface of the electrically conductive thin film. Namely, in the method as described in Patent Document 1, the electrically conductive thin film on which the design is transferred is allowed to be a metal mold and, then, electrodeposition is performed on the design surface, to thereby obtain the electroformed pattern having the design.

According to the above-described Patent Document 1, the electroformed pattern having a design surface on the surface is provided and given a high appraisal in the market; nevertheless, further improvements as described below are required.

(1) Since a character pattern is formed by an electrodeposition pattern forming method, an edge portion (end portion) of a face opposite (hereinafter, referred to also as “fixing face”) to a design face is sometimes rounded. Particularly, a tendency of such rounding is conspicuous when the character pattern is small in size or in width. The electroformed pattern is adhered onto an adherend by an adhesive layer for fixing formed on the fixing face and, when the fixing face is rounded, a necessary amount of adhesive can not be applied and, then, a required adhesion force can not sometimes be obtained. For this account, the electroformed pattern is sometimes dropped off.

(2) At the time the electroformed pattern is peeled off from the electrically conductive thin film, such peeling operation is performed by bending the electrically conductive thin film. For this account, the electrically conductive thin film is deformed and can not be used again.

(3) The electroformed pattern is formed per independently formed character pattern. The thus-formed electroformed pattern is transferred onto a support film such that a design face is exposed. Since the character patterns are each independently formed and the support film is dielectric, it is impossible to perform electroplating on the design face as a finishing treatment. In a case of non-electroplating, since a temperature of a bath becomes about 100° C., the support film becomes soft and; due to expansion and contraction of the film, the character pattern is sometimes dropped off.

(4) Due to the article (3), it is taught in Patent Document 1 that, prior to formation of the electroformed pattern, a thin film layer for decoration is previously formed on the design face of the electrically conductive thin film and, then, the electrodeposition is performed on the thus-formed thin film layer for decoration. By such performance, the electroformed pattern, having the design, which has the thin film layer for decoration on the surface can be obtained. However, such step as described above is troublesome.

### SUMMARY OF THE INVENTION

In order to solve these problems, the present inventor has studied on fixing a metal foil having a design such as a hologram foil which is separately produced and available in the market on a surface of a metal pattern, not directly forming a design on the surface of the metal pattern. The hologram foil is used in many applications such as banknotes and various types of cards for the purpose of prevention of forgery. The hologram foil has a constitution in which a hot-melt adhesive, a metal deposited film, a resin embossed layer and a releasing film for protecting the embossed layer are laminated in this order and is available in the market. The hologram foil is used in a state in which, after it is adhered to paper, a resin card or the like through the hot-melt adhesive layer, the releasing film is peeled off therefrom.

However, when it is intended to adhere a hologram foil to a metal pattern, a general-purpose hot-melt adhesive is inferior in a property of adhesion to a metal surface and, accordingly, fixing of the hologram foil is difficult and, even when such fixing is achieved, problems of peeling-off and the like of the hologram foil is generated.

In order to solve these problems, the present inventor has conducted intensive studies and, as a result, achieved the present invention as described below. Namely, the gist of the present invention is as follows:

(1) a decorative pattern comprising:

a metal pattern,

a resin layer and

a metal foil having a design, said foil being fixed on a surface of the metal pattern through the resin layer;

(2) the decorative pattern as described in (1), in which the resin layer comprises a primer layer formed on the surface of the metal pattern and a hot-melt adhesive layer formed on the primer layer;

(3) the decorative pattern as described in (2), in which the primer layer comprises an acrylic coating material or an epoxy coating material;

(4) the decorative pattern as described in any one of (1) to (3), in which the metal foil having a design is a hologram foil or an electron beam designed foil;

(5) the decorative pattern as described in any one of (1) to (4), in which a resin coating is provided on a surface of the metal foil having a design;

(6) the decorative pattern as described in any one of (1) to (5), in which the metal pattern is an electroformed pattern;

(7) the decorative pattern as described in any one of (1) to (5), in which the metal pattern is an etched image;

(8) a decorative plate, comprising an adherend having a concave portion and a decorative pattern having almost the same shape as that of the concave portion, wherein the decorative pattern is fixed in the inside of the concave portion through a fixing layer for the decorative pattern; and wherein the decorative pattern is such that as described in any one of (1) to (7);

(9) a method for producing a decorative pattern, comprising the steps of:

forming a metal pattern in an aligned and temporarily-bonded state on a support;

forming a primer layer on a surface of the metal pattern; and

heat-bonding under pressure a metal foil having a design, said foil being provided with a hot-melt adhesive layer on a face opposite to a design face, on the surface of the metal pattern through the hot-melt adhesive layer;

(10) method for producing the decorative pattern according to (9), further comprising the step of:

applying a resin coating on a surface of the metal foil having a design heat-bonded under pressure;

(11) a method for producing a decorative pattern, comprising the steps of:

transferring the decorative pattern, being obtained by the method according to (9) or (10) and in an aligned and temporarily-bonded state on a support, to an application tape having an adhesive layer; and

forming a fixing layer for the decorative pattern on an exposed face of the decorative pattern; and

(12) a method for producing a decorative plate, wherein a decorative pattern obtained by the method according to (11) is fitted to a concave portion of an adherend having the concave portion having almost the same shape as that of the decorative pattern and, then, the application tape is peeled off from the decorative pattern.

According to the present invention, a decorative pattern, having a stereoscopic effect and capable of contributing to an enhancement of decorativeness, prevention of forgery and the like, in which a hologram foil or the like is fixed on a surface of a minute metal pattern can be provided.

### BRIEF DESCRIPTION OF THE DRAWINGS

FIG. 1 is a cross-sectional diagram showing one embodiment of a decorative plate according to the present invention;

FIG. 2 is a cross-sectional diagram showing another embodiment of a decorative plate according to the present invention;

FIG. 3 schematically shows one step of a production method according to the present invention;

FIG. 4 schematically shows one step of a production method according to the present invention;

FIG. 5 schematically shows one step of a production method according to the present invention;

FIG. 6 schematically shows one step of a production method according to the present invention;

FIG. 7 schematically shows one step of a production method according to the present invention;

FIG. 8 schematically shows one step of a production method according to the present invention;

FIG. 9 schematically shows one step of a production method according to the present invention;

FIG. 10 schematically shows one step of a production method according to the present invention;

FIG. 11 schematically shows one step of a production method according to the present invention;

FIG. 12 schematically shows one step of a production method according to the present invention;

FIG. 13 schematically shows one step of a production method according to the present invention;

FIG. 14 schematically shows one step of a production method according to the present invention;

FIG. 15 schematically shows one step of a production method according to the present invention;

FIG. 16 schematically shows one step of a production method according to the present invention;

FIG. 17 schematically shows one step of a production method according to the present invention; and

FIG. 18 schematically shows one step of a production method according to the present invention.

### DETAILED DESCRIPTION OF THE INVENTION

Hereinafter, a decorative pattern and a method for producing the decorative pattern according to the present invention will particularly be described with reference to the accompanying drawings.

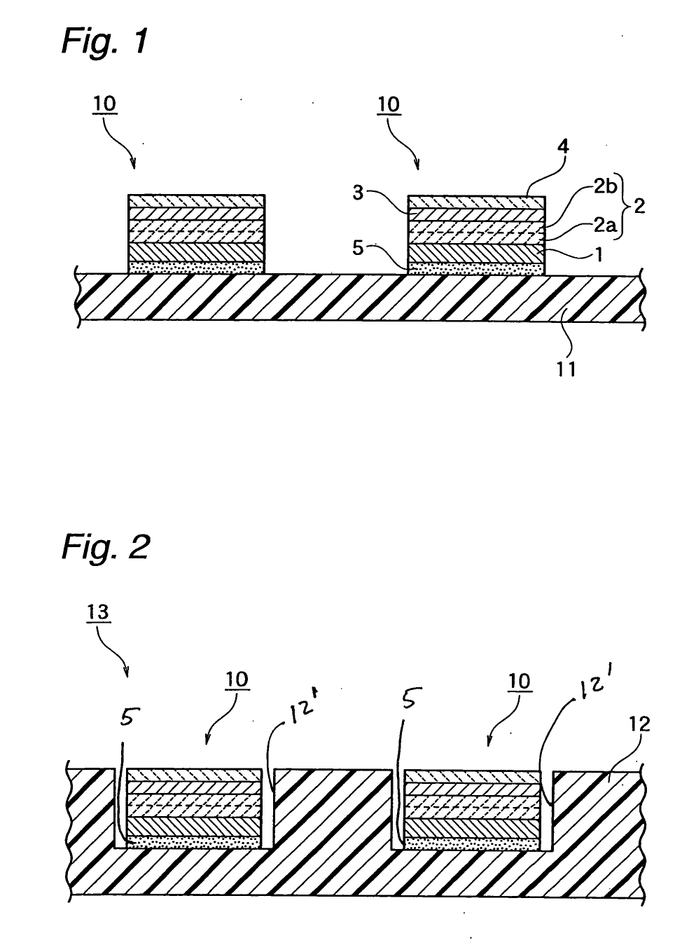

As shown in FIG. 1, the decorative pattern 10 comprises a metal pattern, a resin layer and a metal foil 3 having a design, said foil being fixed on a surface of the metal pattern 1 through the resin layer 2. This decorative pattern 10 ordinarily has a fixing layer 5 for the decorative pattern on a reverse face and is fixed on any one of various types of adherends 11 through the fixing layer 5 for the decorative layer.

The metal pattern 1 may be an electroformed pattern to be produced by a known electrodeposition pattern forming method as described, for example, in JP-A Nos. 7-331479 and 8-27597, or may be a minute pattern to be produced by an etching method, a pressing method or a laser beam cutting method. Among these methods, according to the present invention, particularly, the electroformed pattern, or the minute pattern to be produced by the etching method (hereinafter, referred to also as “etched pattern”) is preferred. According to the present invention, when seen as a whole, the above-described metal pattern 1 constitutes a character or a graphic pattern of a manufacturing company name, a trade name, a trade mark or the like in many cases, but the present invention is not limited thereto and various types of patterns are permissible.

Further, thickness of the metal pattern 1 is, preferably from 50 to 1000 μm, more preferably from 30 to 950 μm and, particularly preferably from 30 to 900 μm. On a surface of the metal pattern 1, finishing plating may be applied.

On the surface of the metal pattern 1, the metal foil 3 having a design is fixed through the resin layer 2. The metal foil 3 having the design is a metal foil on which various types of patterns (design) are formed and typically includes a hologram foil or an electron beam designed foil. The hologram foil has a design, being produced through image-taking and printing by a laser beam, which has a stereoscopic effect and changes the appearance of design in accordance with a viewpoint. The electron beam designed foil is produced through image-taking and printing by an electron beam, and a design having a stereoscopic effect is recorded thereon in as same manner as in the hologram foil. A distinction between the hologram foil and the electron beam designed foil is not always clear and, according to the present invention, these foils are generally called as “hologram foil”. The hologram foil is used in many applications such as banknotes and various types of cards for the purpose of prevention of forgery and the like. The hologram foil has a constitution in which a hot-melt adhesive, a metal deposited film, an embossed layer made of resin and a releasing film for protection of the embossed layer are ordinarily laminated in this order and is available in the market under the name of a hot stamping foil or the like. The hologram foil is used by adhering to paper, a resin card or the like through the hot-melt adhesive layer and, then, peeling off the releasing film therefrom.

Further, thickness of the metal foil 3 having the design is preferably from 5 to 15 μm, more preferably from 6 to 10 μm and particularly preferably from 6 to 8 μm. In such commercial hologram foil, the embossed layer made of resin is further formed on the surface of the metal foil 3 having the design (metal deposition layer) in some cases.

This metal foil 3 having a design is fixed on the surface of the metal pattern 1 through the resin layer 2. The resin layer 2 is not particularly limited, so long as it can firmly fix the metal foil 3 having a design on the surface of the metal pattern 1. Although the hot-melt adhesive for the above-described commercial hologram foil is firmly adhered to paper or a resin, adhesion thereof to a metal is insufficient. However, from the standpoint of cost, it is desirable to use the commercial hologram foil.

Then, according to the present invention, in order to firmly adhere the commercial hologram foil, it is recommended that a primer layer 2a is provided on the surface of the metal pattern 1. The primer layer 2a is not particularly limited, so long as it intervenes between the surface of the metal pattern 1 and the hot-melt adhesive 2b and firmly adheres the both to each other; however, as a result of conducting studies on hot-melt adhesives in various types of commercial hologram foils and various types of resin materials, as for the primer layer 2a, an acrylic coating material or an epoxy coating material is particularly preferably used. Thickness of the primer layer 2a is preferably from 1 to 10 μm, more preferably from 1 to 5 μm and particularly preferably from 1 to 2 μm.

In a case in which the resin layer 2 comprises the primer layer 2a and the hot-melt adhesive 2b, thickness of the hot-melt adhesive 2b is, preferably, from 1 to 15 μm, more preferably from 1 to 10 μm and, particularly preferably, from 2 to 3 μm.

It is particularly preferable, as described above, that the resin layer 2 comprises the primer layer 2a and the hot-melt adhesive 2b; however, it is not limited to such constitution as described above, so long as the resin layer 2 firmly adheres the surface of the metal pattern 1 and the hot-melt adhesive 2b to each other and it may be a monolayer or formed by other layers than the above-described layers. Further, thickness of the resin layer 2 is preferably from 5 to 15 μm, more preferably from 5 to 10 μm and particularly preferably from 5 to 8 μm.

As for the metal foil 3 having a design, when the above-described commercial hologram foil is used, the embossed layer made of resin is ordinarily formed on the surface of the metal deposited film. According to the present invention, inclusive of the above-described case, a resin coating 4 may be applied on the surface of the metal foil 3 having a design. By the resin coating, abrasion resistance is enhanced and, also, fouling prevention is realized. Further, by applying the resin coating also on a side face portion of the decorative pattern 10, exfoliation between layers constituting the decorative pattern 10 can be prevented. Still further, when the decorative pattern 10 has a sharp shape, there is a case in which skin is hurt by a contact or a fiber of clothes is hooked; however, by applying the resin coating, these problems can be solved. Even still further, when the decorative pattern is the etched pattern, there is a case in which a side face of the pattern becomes rough as a result of side-etching. In this case, the adhesive is liable to be remained on a face at the side of the pattern in a state of being adhered thereto. In order to solve these problems, the resin coating may be applied on the side face of the pattern. Since the side face becomes flat by the resin coating, such remaining adhesive can be reduced.

The resin coating 4 is formed by preferably an acrylic-base ultraviolet curing polymer, an acrylic- and epoxy mixed-base or a urethane-base thermosetting polymer or the like, and thickness thereof is not particularly limited and is preferably from 5 to 15 μm, more preferably from 5 to 10 μm and particularly preferably from 5 to 8 μm.

The decorative pattern 10 according to the present invention has a constitution as described above and, ordinarily, is fixed on various types of adherends 11 through the fixing layer 5 for the decorative pattern formed on a reverse face of the metal pattern 1. The fixing layer 5 for the decorative pattern is not particularly limited, so long as it allows the decorative pattern 10 to be firmly adhered to the adherend 11, and a general-purpose adhesive, tacky agent or the like can be used. In view of capability of preventing running-off of adhesive and obtaining a high adhesion force, the hot-melt adhesive, the ultraviolet curing adhesive, or a mixed adhesive of these adhesives is preferably used. The ultraviolet curing adhesive has a property such that it is polymerize-cured by being irradiated by an ultraviolet ray and reduces or loses the adhesion force and various types of ultraviolet curing adhesives are known. Ordinarily, the adhesion force thereof prior to such irradiation of the ultraviolet ray is 1270 g/25 mm-width or more and, by being irradiated by the ultraviolet ray, the adhesion force thereof is sharply reduced to be 30 g/25 mm-width or less.

Representative examples of ultraviolet curing pressure-sensitive adhesives are by no means limited and a rubber pressure-sensitive adhesive in which a photopolymerizable compound such as an addition-polymerizable compound having at least 2 unsaturated bonds or an alkoxysilane having an epoxy group, and a photopolymerization initiator such as a carbonyl compound or an organic sulfur compound, a peroxide, an amine, or onium salt compound are compounded with each other or an acrylic-base pressure-sensitive adhesive or the like can be mentioned (refer to JP-A No. 60-196956). Amounts of the photopolymerizable compound and the photopolymerization initiator to be compounded are, ordinarily, 10 to 500 parts by weight and 0.1 to 20 parts by weight per 100 parts of the base polymer, respectively.

The hot-melt adhesive has a property such that it sticks to the adherend in a melting state and, by cooling, it is solidified and adheres thereto. Various types of hot-melt adhesives are known. According to the present invention, particularly, as for the hot-melt adhesive, AD-HM1 (trade name; available from Jujo Chemical Co., Ltd.) is favorably used.

For example, in a case in which the fixing layer 5 is formed by using the mixed adhesive of the hot-melt adhesive and the ultraviolet curing adhesive, even when an ultraviolet ray irradiation condition is not appropriate and, then, an adhesion property thereof is not fully exhibited, since the adhesion force is complemented by the hot-melt adhesive, the decorative pattern can firmly be fixed. Further, by using the hot-melt adhesive or the tacky agent, the decorative pattern can be fixed without being subjected to the ultraviolet ray irradiation.

Thickness of the fixing layer 5 for the decorative pattern is not particularly limited and is preferably from 10 to 60 μm. more preferably from 15 to 50 μm and particularly preferably from 15 to 30 μm.

The adherend 11 to which the decorative pattern 10 is adhered is any one of various types of devices to which the product logo or the like is adhered and is not limited to a specific shape and may be in a planar shape or a curved face shape. The adherend 11 is made of a metal or various types of synthetic resins and its material is not particularly limited to.

When the decorative pattern 10 is fixed to the surface of the adherend 11, since it protrudes from the surface of the adherend, it may sometimes be dropped by a mechanical shock or, when the decorative pattern 10 has a sharp shape, there is a case in which skin is hurt by a contact or a fiber of clothes is hooked. In order to prevent these problems, it is preferable that the decorative pattern 10 is fit in the inside of a concave portion of the adherend which has the concave portion having almost the same shape as that of the decorative pattern 10 and, then, fixed therein.

Namely, as shown in FIG. 2, a decorative plate 13 according to the present invention comprises an adherend 12 having a concave portion and the decorative pattern 10 having almost the same shape as that of the concave portion, in which the decorative pattern 10 is fixed in the inside of the concave portion through the fixing layer 5.

Further, thickness of the adherend 12 is not particularly limited, varies depending on applications of the decorative plate 13, is suitably set according to an entire thickness of the decorative pattern 10 and the fixing layer and is ordinarily from about 500 to about 5000 μm.

The concave portion in which the decorative pattern 10 is put is formed on a surface of the adherend 12. A method for forming the concave portion varies depending on a material of the adherend 12 and is properly selected in accordance with the material. For example, it may be a press forming method or an etching method and, in a case that the material is a synthetic resin, it may be a forming method by using a metal mold. A contour shape of the concave portion is almost the same as that of the decorative pattern 10. Namely, the width and the length of the concave portion are set to be the same as or a little larger than those of the decorative pattern 10. When they are set to be a little larger, the concave portion has a similar figure to that of the decorative pattern 10 and the width and the length thereof are set to be larger than those of the decorative pattern 10 by about 100 to about 300 μm.

In the decorative plate 13 according to the present invention, the decorative pattern 10 is fixed in the inside of the concave portion through the fixing layer 5. Thickness of the fixing layer 5 is as described above.

Further, in the decorative plate 13 according to the present invention, a total thickness of the decorative pattern 10 and the fixing layer 5 is, based on depth of the concave portion, in the range of preferably from −200 μm to +50 μm, more preferably from −150 μm to ±0 μm and particularly preferably from −100 μm to −50 μm of the depth of the concave portion.

According to the decorative plate 13 of the present invention, since the decorative pattern 10 is fixed in the inside of the concave portion of the adherend 12 through the fixing layer 5, even if the decorative pattern is minute, a pattern is not dropped.

Further, by setting the total thickness of the decorative pattern 10 and the fixing layer 5, and the depth of the concave portion to be such value as described above, an acute angle portion at an end portion of the decorative pattern becomes not protruded from the surface of the adherend; therefore, even when the pattern has a sharp edge, an abrasion and an injury caused by contact can be prevented.

Hereinafter, methods for producing the decorative pattern 10 and the decorative plate 13 will be described.

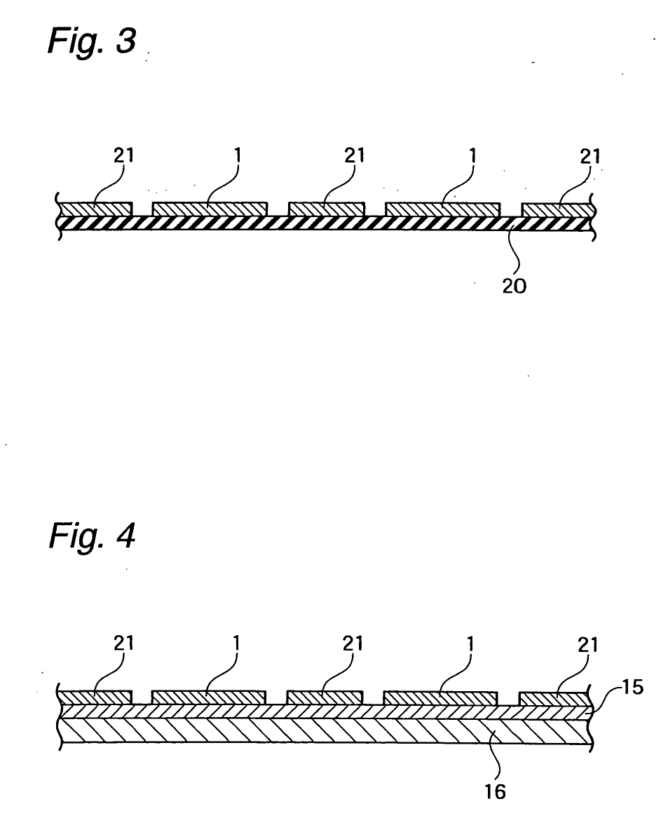

Firstly, as shown in FIG. 3, the metal pattern 1 is formed on a support 20 in an aligned and temporarily-bonded state. Such production of the metal pattern 1 as described above may be carried out by applying an electrodeposition pattern forming method as described in, for example, JP-A Nos. 7-331479 and 8-27597. Further, by using a tacky sheet or the like as the support 20, a metal foil is applied on the tacky sheet and, then, by performing patterning on the metal foil by an etching method, a pressing method or a laser beam cutting method, the metal pattern 1 which is aligned and temporarily-bonded on the tacky sheet may be formed.

Further, according to the present invention, at the same time as the metal pattern 1 is formed, a pattern 21 for a process control may be formed such that it surrounds the metal pattern 1. The pattern 21 for the process control is finally removed; however, at the time of forming the fixing layer 5 described below, the pattern 21 for the process control can be used as a mask. Further, in the pattern 21 for the process control, a hole for use in a position adjustment or the like may be formed.

Still further, the term “the metal pattern 1 in an aligned and temporarily-bonded state” means a state in which the metal pattern, as a whole, shows characters and graphic patterns of a manufacturing company name, a trade name, a trade mark or the like and, also, a state in which the metal pattern is fixed on the support 20 in a peelable manner.

As for such metal pattern 1 as described above, from the standpoint of easiness of production or the like, particularly, an electroformed pattern or an etched pattern is preferred.

Formation of the etched pattern is performed by applying a metal foil on the tacky sheet by using a tacky sheet as the support 20, forming a resist film on the metal foil, performing each operation of exposing, developing and etching and, finally, removing the resist film. By such method as described above, the etched pattern as the metal pattern 1 can be obtained on the tacky sheet in an aligned and temporarily-bonded state. In order to facilitate peeling-off of the etched pattern in the subsequent step, it is preferable to use an ultraviolet curing tacky sheet as the tacky sheet.

Further, when the electrodeposition pattern forming method is adopted, it is preferable that, in accordance with a method as described in JP-A No. 7-331479, firstly as shown in FIG. 4, an electrically conductive film 15 is formed on a surface of a metal plate 16 and, then, the metal pattern 1 is formed on a surface of the thus-formed electrically conductive film 15 by using the electrodeposition pattern forming method.

Next, the metal pattern 1 formed on the surface of the electrically conductive film 15 is transferred to an application tape 22. Specifically, the application tape 22 comprising a substrate and an adhesive layer is applied on a metal pattern formed face and, thereafter, by peeling off the application tape 22, the metal pattern 1 is peeled off in a state of being transferred onto an adhesive layer and, accordingly, the metal pattern 1 can be transferred to the application tape 22.

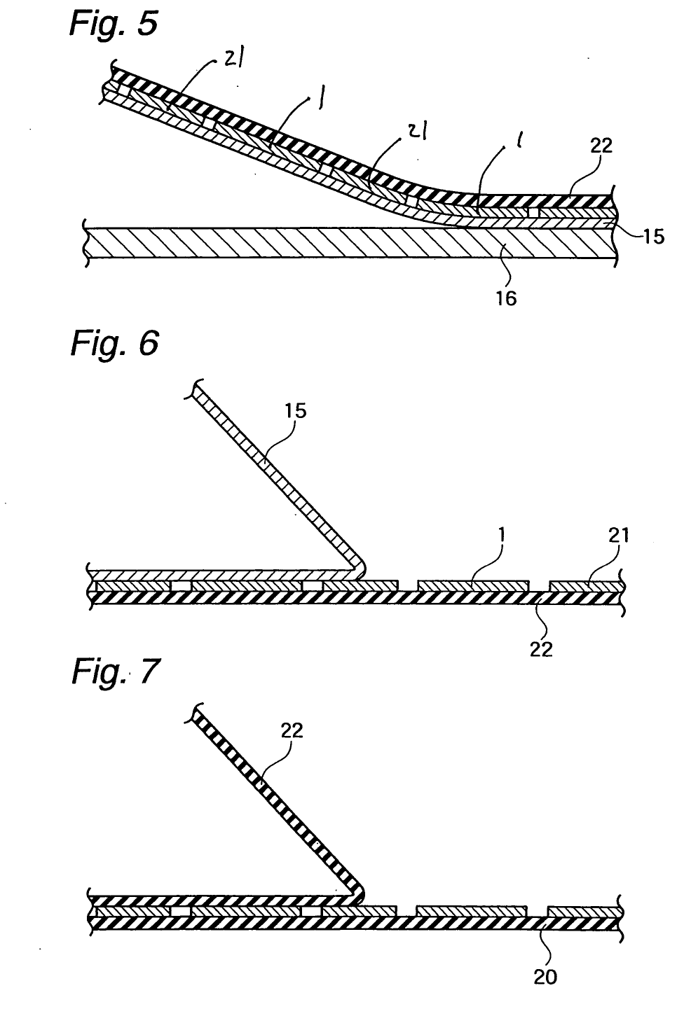

Further, as shown in FIG. 4, when the electrically conductive film 15 is formed on the surface of the metal plate 16 and, then, the metal pattern 1 is formed on the surface of the electrically conductive film 15, it is preferable that, as shown in FIG. 5, the metal pattern 1 is peeled off in a state of being sandwiched by the electrically conductive film 15 and the application tape 22 and, thereafter, as shown in FIG. 6, the electrically conductive film 15 is peeled off from the metal pattern face. Bypassing through such steps as described above, when the metal pattern 1 is transferred to the application tape 22, an addition of an excess deformation stress to the metal pattern 1 or scattering of the metal pattern 1 can be prevented. Subsequently, as shown in FIG. 6, by peeling off the electrically conductive film 15, transfer of the metal pattern 1 onto the application tape 22 is completed.

By passing through these steps, the metal pattern 1 is formed on the application tape 22 in an aligned and temporarily-bonded state. In this state, various steps to be described below such as formation of a resin layer and fixing of a metal foil having a design may be performed, but, preferably, as shown in FIG. 7, the metal pattern 1 which is in an aligned and temporarily-bonded state on the application tape 22 is transferred onto the support 20. By such transfer, the electroformed pattern face (bottom face, at the time of electrodeposition) which is in contact with the electrically conductive film 15 at the time of forming the electroformed pattern is set on the support 20 and the reverse side thereof (top face, at the time of electrodeposition) is exposed. The bottom face of the electroformed pattern is flat and free of a round portion at an end portion thereof. Accordingly, when the fixing layer is formed on the bottom face, it is surely fixed on an adherend.

When a re-transfer is performed in the same manner as in the above case by using the application tape 22, a support having a larger adhesion force than that of the application tape 22 is selected as the support 20. Further, particularly, when the ultraviolet curing tacky sheet is used as the application tape 22, the metal pattern 1 is easily transferred to the support 20 by, after the support 20 is applied, subjecting the adhesive layer of the application tape 22 to ultraviolet ray-curing to reduce the adhesion force thereof at the side of the application tape 22.

Thus, as shown in FIG. 3, a group of metal patterns 1 which are in the aligned and temporarily-bonded state on the support 20 can be obtained.

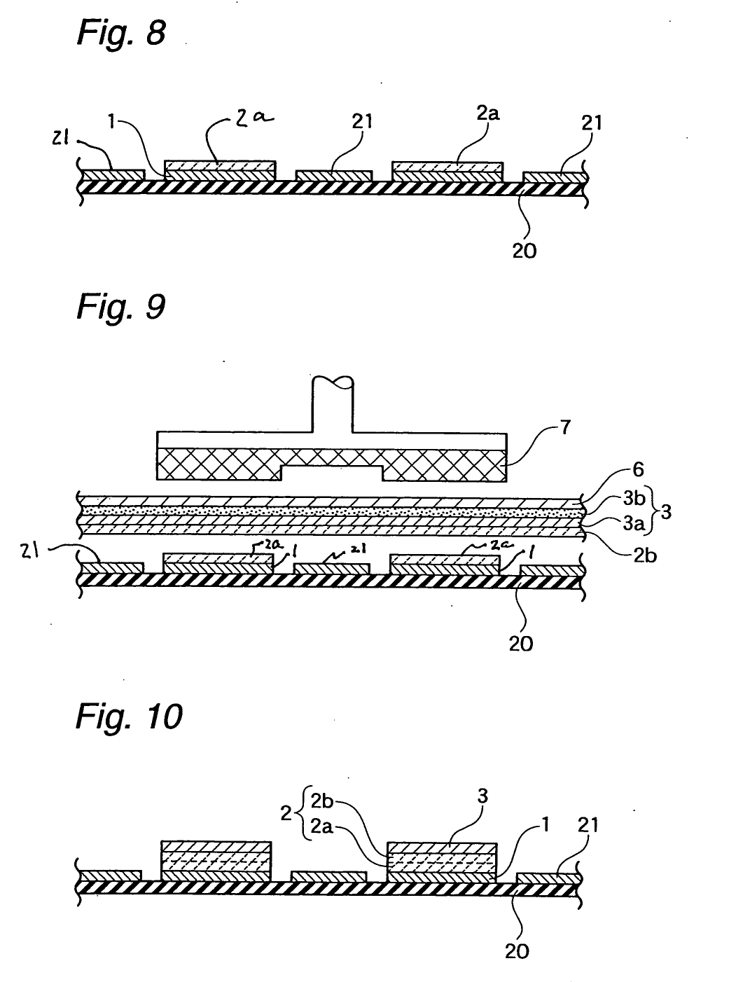

Next, in the production method according to the present invention, as shown in FIG. 8, the primer layer 2a is formed on an exposed face of the metal pattern 1. The primer layer 2a is not particularly limited, so long as it intervenes between the surface of the metal pattern 1 and the hot-melt adhesive 2b and can firmly adhere the both to each other, and, as a result of studies on hot-melt adhesives in various types of commercial hologram foils and various types of resin materials, an acrylic coating material or an epoxy coating material is favorably used as the primer layer 2a. After the coating material is applied, baking and drying are performed on the thus-applied coating material under appropriate conditions in accordance with the type of the coating material, to thereby form the primer layer 2a. Further, on this occasion, it is possible to use a mask having an opening of almost the same shape as that of the metal pattern 1. Namely, by applying the coating material after positions of the opening of the mask and the metal pattern 1 are adjusted to each other, the primer layer 2a can be formed only on an exposed face of the metal pattern.

Next, as shown in FIG. 9, the metal foil 3 having a design such as the hologram foil is adhered onto the primer layer 2a. The hologram foil ordinarily has a constitution in which the hot-melt adhesive 2b, the metal foil 3 having a design (metal deposited film 3a, embossed layer 3b made of resin) and a releasing film 6 for protecting the embossed layer are laminated in this order and is available in the market under the name of hot stamping foil or the like. On one face of the metal foil 3 having a design, the hot-melt adhesive layer 2b is formed and, according to the present invention, by heat-bonding under pressure the hot-melt adhesive layer 2b and the primer layer 2a to each other, the metal foil 3 having a design is adhered to the metal pattern 1.

It is preferable that such heat-bonding under pressure is performed by using a heat resistant rubber 7. As for the heat resistant rubber 7, such heat-resistant rubber 7 as having a similar shape to that of the metal pattern 1 but having a size a little larger than that of the metal pattern 1 is used. Specifically, a pressure-bonding face of the heat resistant rubber having width and length larger than those of the metal pattern 1 each by from about 100 to about 300 μm is formed. By heating while adding pressure by using such heat resistant rubber, the metal foil 3 having a design is adhered to the metal pattern 1 through the hot-melt adhesive layer 2b and the primer layer 2a.

Conditions of the heat-bonding under pressure are appropriately selected in accordance with types of hot-melt adhesives. Ordinarily, it is preferable that a surface temperature of the heat resistant rubber is from 150 to 190° C.; a pressure is from 3 kg/cm² to 8 kg/cm²; time duration is-from about 3 seconds to about 5 seconds.

Next, when the releasing film 6 is laminated, it is peeled off. Then, at the time the metal foil 3 having a design is peeled off from the surface of the metal pattern, since the metal foil 3 having a design is firmly adhered to the surface of the metal pattern, portions thereof remain in a state of being adhered thereto and only the metal foil 3 in the rest portions is removed. As a result, as shown in FIG. 10, the decorative pattern 10 comprising the metal pattern in which the metal foil 3 having a design is firmly adhered to the surface of the metal pattern is obtained. Further, in FIG. 10, the metal deposited film 3a and the embossed layer made of resin 3b are described in lumping together as the “metal foil 3 having a design”.

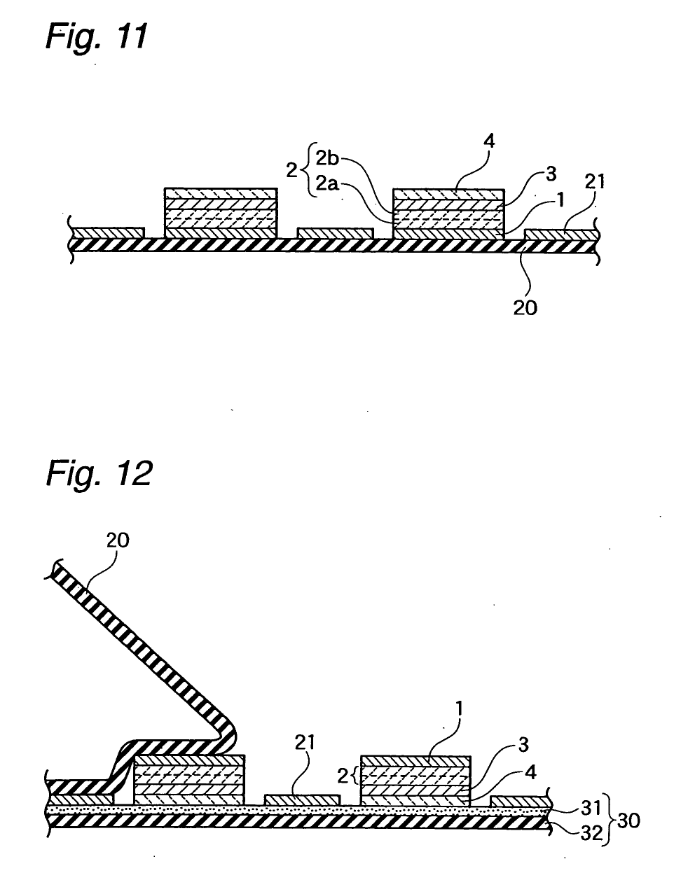

Thereafter, if necessary, as shown in FIG. 11, the resin coating is applied on the surface of the decorative pattern 10. Further, when the above-described commercial hologram foil is used as the metal foil 3 having a design, the embossed layer made of resin is, ordinarily, formed on the surface of the metal deposited film. According to the present invention, inclusive of this case, the resin coating 4 may be applied on the surface of the metal foil 3 having a design. By applying the resin coating 4, abrasion resistance is enhanced and fouling prevention is realized. Further, although not shown, by applying the resin coating also on a side face portion of the decorative pattern 10, exfoliation between layers which constitute the decorative pattern 10 can be prevented. Still further, when the decorative pattern 10 has a sharp shape, there is a case in which skin is hurt by a contact or a fiber of clothes is hooked; however, by applying the resin coating, these problems can be solved. Even still further, when the decorative pattern is the etched pattern, there is a case in which a side face of the pattern becomes rough as a result of side-etching. In this case, the adhesive is liable to be remained on a face at the side of the pattern in a state of being adhered thereto. In order to solve these problems, the resin coating may be applied on the side face of the pattern. Since the side face becomes flat by the resin coating, such remaining adhesive can be reduced.

The resin coating 4 is formed by an acrylic-base ultraviolet curing polymer, an acrylic and epoxy mixed-based or a urethane-based thermosetting polymer or the like, and the resin coating is applied by an appropriate method in accordance with each resin. For example, when the resin coating 4 is formed by using the thermosetting polymer, the resin is applied by a technique such as gun spraying or silk printing and, then, subjected to a thermosetting for from 50 minutes to 30 minutes at from 130 to 150° C. On this occasion, as for the support 20, it is preferable to use a polyethylene terephthalate film having a high heat resistance or the like as a substrate. When the resin coating 4 is formed by using the ultraviolet curing polymer, the resin is applied by using a technique of, for example, silk printing and, then, irradiated by an ultraviolet ray, to thereby cure the resin. Further, on this occasion, it is possible to use a mask which has an opening of almost the same shape as that of the metal pattern 1. Namely, by applying the coating material after positions of the opening of the mask and the decorative pattern 10 are adjusted to each other, the resin coating 4 can be formed only on an exposed face of the decorative pattern 10.

Once such a resin coating is applied, an adhesive which forms the fixing layer to be used in the subsequent step to be described below or another adhesive for the application tape to be used in a transfer step can be prevented from remaining on the surface and the side face of the decorative pattern 10. For this account, since a stringiness (thread formation) of the adhesive in the transfer step or the fixing step is not generated, the decorative pattern and decorative plate free of fouling can be produced.

For the same object, a releasing treatment may be provided on the surface of the resin coating of the decorative pattern 10. By such treatment, not only the adhesive is prevented from remaining on the pattern, but also, when an application tape 30 is peeled off from the decorative pattern 10 in the final step as described below, the decorative pattern 10 can be prevented from being adhered to a side of the application tape 30 and peeled off.

Next, on the decorative pattern 10 in the aligned and temporarily-bonded state on the support 20, the fixing layer 5 for the decorative pattern is formed. The fixing layer 5 is formed on a reverse face (bottom face, at the time of electrodeposition) of the decorative pattern 10. For this account, the decorative pattern 10 is further transferred to another application tape 30 and, as shown in FIG. 12, the reverse face of the decorative pattern 10 is allowed to be exposed. Further, in FIG. 12, although a diagram is deformed in a direction of height, since a difference of height between the decorative pattern 10 and the pattern 21 for the process control can be actually disregarded, there is no problem in such transfer.

The decorative pattern 10 transferred to the application tape 30 is re-transferred to an adherend at a final step. Therefore, as for an adhesive layer 31 of the application tape 30, a weak tacky agent having re-releasable property or an ultraviolet curing tacky agent which reduces an adhesion force thereof by being irradiated by an ultraviolet ray or the like can be used.

However, in a case where the resin coating is applied on the surface of the decorative pattern 10 or in a case where a releasing treatment is performed, since the adhesion force between the surface of the decorative pattern and the application tape 30 does not become large, not only the weak tacky agent or the ultraviolet curing tacky agent is used, but also various types of adhesives can be used as the adhesive layer 31 of the application tape 30. Particularly, by using an adhesive the same as or similar to the fixing layer 5 which is used for fixing the decorative pattern 10 to the adherend in the final step, the adhesive which is run off from the decorative pattern 10 can be removed from a peripheral portion of the decorative pattern in a state of being unified with the adhesive layer 31.

The adhesive which forms the fixing layer 5 is as described above, and the term “an adhesive similar to the fixing layer 5” as used herein is intended to include an adhesive which is within the scope of the description related to the adhesive which forms the above-described fixing layer 5, even though it may be different from the adhesive which actually forms the fixing layer 5 in the points of the composition and physical property.

It is preferable that, a substrate 32 of the application tape 30 is subjected to a corona discharge treatment, and the adhesive layer 31 is formed on the substrate 32. By such treatment, it becomes possible to enhance the adhesion force between the substrate 32 and the adhesive layer 31 and, at the time the application tape 30 is peeled off from the adherend in the final step, the adhesive of the adhesive layer 31 is prevented from remaining on the decorative pattern 10.

Further, in a case where the ultraviolet curing adhesive is contained in the adhesive layer 31, as for the substrate 32, various types of transparent or translucent resin film are used. “The case where the ultraviolet curing adhesive is contained in the adhesive layer 31” is intended to include both of a case in which the application tape 30 is a general-purpose UV tape (ultraviolet curing tacky tape) and a case in which the adhesive layer 31 is a mixed adhesive of the hot-melt adhesive and the ultraviolet curing adhesive.

After the decorative pattern 10 is transferred to the application tape 30 having the adhesive layer 31 in a manner as described above, when the ultraviolet curing adhesive is contained in the adhesive layer 31, as shown in FIG. 13, the adhesion force is reduced by irradiating the ultraviolet ray. On this occasion, by irradiating the ultraviolet ray from a side of the substrate 32, the adhesion layer 31 containing the ultraviolet curing adhesive is sufficiently cured as a whole, and the adhesion force in a portion to which the decorative patter 10 is fixed is also reduced. Further, such ultraviolet ray irradiation may be conducted after formation of the fixing layer 5 to be described below.

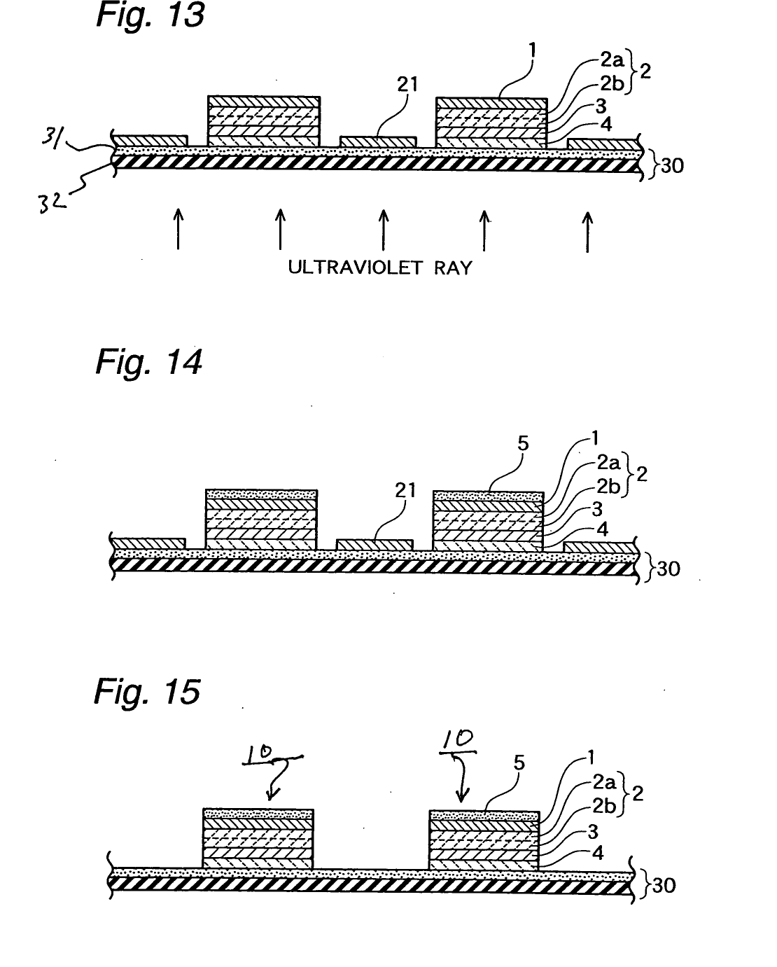

Next, as shown in FIG. 14, the fixing layer 5 is further formed on a face on which the decorative pattern is fixed. Thickness of the fixing layer 5 is as described above. A composition of the adhesive to be used in the fixing layer 5 is as described above and may be the same as or different from that of the adhesive layer 31 of the application tape 30, however it has preferably the same or similar composition with the adhesive layer 31.

Formation of the fixing layer 5 is performed by a silk printing method, a spray method or the like and, preferably, by the silk printing method, after, for example, the above-described adhesive is optionally diluted with a solvent.

At the time of forming the fixing layer 5, a mask which has an opening having almost the same shape as that of the decorative pattern 10 may be used. Namely, by applying or spraying the adhesive after positions of the opening of the mask and the decorative pattern 10 are adjusted to each other, the fixing layer 5 can be formed on an exposed face of the decorative pattern 10. On this occasion, by forming the fixing layer 5 to be a little smaller than an area of the exposed face of the decorative pattern 10, running-off of the adhesive after fixation can be prevented. Further, as described above, the pattern 21 for the process control is previously formed and the thus-formed pattern 21 for the process control can be used as the mask.

Further, when the pattern 21 for the process control is formed as the mask, after the adhesive is applied or sprayed, the pattern 21 for the process control is removed.

By passing through such steps as described above, as shown in FIG. 15, the fixing layer 5 can be formed on the exposed face of the decorative pattern 10 and, accordingly, running-off of the adhesive after applied on the adherend 11 can be reduced. Further, in a resultant state, the releasing film maybe applied on the fixing layer 5 and, then, aged.

The thus-obtained decorative pattern 10 is fixed on the adherend 11 through the fixing layer 5 and, thereafter, by peeling off the application tape 30, the decorative plate on which the decorative pattern 10 is fixed can be obtained. Further, formation of the resin coating 4 on the surface of the decorative pattern may be performed after fixing to the adherend is performed.

Materials and shapes of the adherend 11 vary depending on applications of the decorative plate and are not particularly limited; however, from the above-described reason, the adherent 12 having the concave portion may sometimes be favorably used. Hereinafter, a case wherein the adherend 12 having the concave portion is used is described.

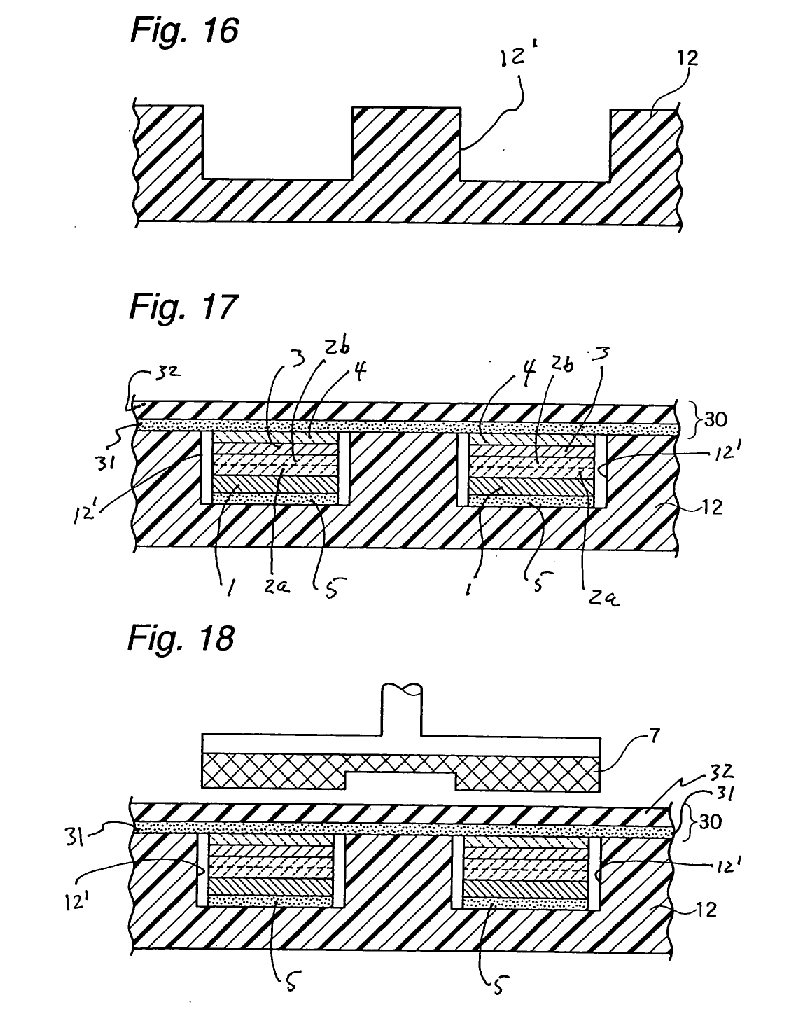

Firstly, the adherend 12 which has the concave portion having almost the same shape as that of the decorative pattern 10 is prepared (see FIG. 16). The adherend 12 may be made of a metal or various types of synthetic resins and is not limited to a specific material. Further, thickness of the adherend 12 is not particularly limited and varies depending on applications of the decorative plate but is, ordinarily, from about 500 to about 1000 μm. A method for forming the concave portion varies depending on materials of the adherend 12 and the method in accordance with a material is appropriately selected. For example, a press-forming method or an etching method is permissible. In a case of using a synthetic resin, a forming using a metal mold is permissible. A contour shape of the concave portion is almost the same as that of the decorative pattern 10. Namely, the width and the length of the concave portion are set to be the same as or a little larger than those of the decorative pattern 10. When the concave portion is set to be a little larger, it has similar figure to that of the decorative pattern 10 and the width and the length thereof are set to be larger than those of the decorative pattern 10 by about 100 to about 300 μm. The depth of the concave portion is, as described above, appropriately set taking thickness of the decorative pattern 10 and the fixing layer 5 into consideration.

Next, positions of the concave portion of the adherend 12 and the decorative pattern 10 are allowed to be in conformity with each other such that the decorative pattern 10 is fixed in the inside of the concave portion through the fixing layer 5 and, then, the decorative pattern 10 is fit in the inside of the concave portion through the fixing layer 5 (see FIG. 17).

Next, when the fixing layer 5 contains the ultraviolet curing adhesive, the ultraviolet ray is irradiated from the side of the application tape and, further, heating, or heating and pressurizing are performed from the side of the application tape (see FIG. 18). In a heating, or heating and pressurizing treatment, a heat resistant rubber stamp 7 having the same size as that of the decorative pattern 10 is preferably used. Conditions of the treatment are appropriately selected in accordance with properties of hot-melt adhesives to be used; however, the temperature of a surface of the rubber is preferably from 90 to 150° C. and, more preferably, from 90 to 130° C.; a pressure is, preferably, from 3 to 5 kg/cm²; and a pressing time duration is from 5 to 15 seconds. At the time of irradiation of the ultraviolet ray, since the fixing layer 5 which is positioned under the decorative pattern 10 is covered by the decorative pattern 10, the ultraviolet ray does not reach the fixing layer 5 to allow it to maintain an uncured state and, accordingly, the decorative pattern 10 can be fixed in the inside of the concave portion-with a sufficient adhesion force. Further, even when the irradiation of the ultraviolet ray is not appropriate and excessively cured the ultraviolet curing adhesive, since the adhesion force is complemented by the hot-melt adhesive, the decorative pattern 10 can firmly be fixed in the inside of the concave portion. On the other hand, the adhesive run off to a peripheral portion of the decorative pattern 10 is polymerized and cured by being irradiated with the ultraviolet ray and, then, forms a cured substance unified with the adhesive layer 31 of the application tape 30. Particularly, when the adhesive layer 31 of the application tape 30 and the fixing layer 5 are formed by using the same or a similar adhesive, the both are firmly unified.

Further, when the fixing layer 5 is formed by using the hot-melt adhesive, as shown in FIG. 18, heating, or heating and pressurizing are performed from the side of the application tape 30, namely, from the side of the substrate 32 of the tape 30. As a result, the decorative pattern 10 can be fixed in the inside of the concave portion through the fixing layer 5. On the other hand, the adhesive run off in the peripheral portion of the decorative pattern 10 forms a rigid substance and is unified with the adhesive layer 31.

In the last, when the application tape 30 is peeled off from the adherend 12, the tape 30 is peeled off together with the adhesive layer 31 and the rigid substance of the adhesive for the fixing layer run off from the decorative pattern on the substrate 32. Since the adhesive run off in the peripheral portion of the decorative pattern 10 is unified with the adhesive layer 31, the rigid substance of the adhesive for the fixing layer does not remain on the surface of the adherend 12 or the peripheral portion of the decorative pattern 10. As a result, since the decorative pattern 10 is fixed in the inside of the concave portion of the adherend 12 through the fixing layer 5, the decorative plate 13 according to the present invention as shown in FIG. 2 can be obtained.

Particularly, when the resin coating is provided on the surface and the side face of the decorative pattern 10, the adhesive which forms the fixing layer 5 or the adhesive layer 31 of the application tape 30 to be used in the transfer step can be prevented from remaining on the surface and the side face of the decorative pattern 10. For this account, in the transfer step or the fixing step, the stringiness (thread formation) of the adhesive is not generated and, accordingly, the decorative plate 13 free of fouling can be produced.

Further, when the releasing treatment is performed on the surface of the decorative pattern 10, not only the adhesive is prevented from remaining on the surface of the decorative pattern 10, but also, when it is intended to peel off the application tape 30 from the decorative pattern 10, since such peeling-off is surely performed between the application tape and the surface of the decorative pattern, the decorative pattern 10 is prevented from being peeled off while being adhered to the side of the application tape 30 and, accordingly, the decorative pattern 10 comes to be surely fixed in the inside of the concave portion of the adherend 12.

Still further, when the ultraviolet curing adhesive is contained in the fixing layer 5, by performing aging if necessary, the adhesion force of an uncured substance (adhesive) of the ultraviolet curing adhesive is further enhanced and, accordingly, the decorative pattern 10 can firmly be adhered to the inside of the concave portion of the adherend 12.

Even still further, when the hot-melt adhesive is contained in the adhesive constituting the fixing layer 5, immediately after the heat-bonding under pressure or, preferably, while being in a state in which the temperature of the adhesive is 50° C. or more, the application tape 30 is preferably peeled off. When the temperature is unduly decreased, the adhesion force of the hot-melt adhesive becomes high and, then, peeling-off becomes difficult or the adhesive run off in the peripheral portion of the decorative pattern 10 may sometimes remain.

According to the present invention, a decorative pattern, having a stereoscopic effect and capable of contributing to an enhancement of decorativeness, prevention of forgery and the like, in which a hologram foil or the like is fixed on a surface of a minute metal pattern can be provided.

1. A decorative pattern comprising:
a metal pattern,
a resin layer and
a metal foil having a design, said foil being fixed on a surface of the metal pattern through the resin layer.

2. The decorative pattern according to claim 1, wherein the resin layer comprises a primer layer formed on the surface of the metal pattern and a hot-melt adhesive layer formed on the primer layer.

3. The decorative pattern according to claim 2, wherein the primer layer comprises one of an acrylic coating material or an epoxy coating material.

4. The decorative pattern according to claim 1, wherein the metal foil having a design is a hologram foil or an electron beam designed foil.

5. The decorative pattern according to claim 1, wherein a resin coating is provided on a surface of the metal foil having a design.

6. The decorative pattern according to claim 1, wherein the metal pattern is an electroformed pattern.

7. The decorative pattern according to claim 1, wherein the metal pattern is an etched metal pattern.

8. A decorative plate, comprising an adherend having a concave portion and a decorative pattern having substantially the same shape as that of the concave portion, wherein the decorative pattern is fixed in the inside of the concave portion through a fixing layer for the decorative pattern; and wherein the decorative pattern comprises:
a metal pattern,
a resin layer and
a metal foil having a design, said foil being fixed on a surface of the metal pattern by the resin layer.

9. A method for producing a decorative pattern, comprising the steps of:
forming a metal pattern in an aligned and temporarily-bonded state on a support;
forming a primer layer on a surface of the metal pattern; and
heat-bonding under pressure a metal foil having a design, said foil being provided with a hot-melt adhesive layer on a face opposite to a design face, on the surface of the metal pattern through the hot-melt adhesive layer.

10. The method for producing the decorative pattern according to claim 9, further comprising the step of:
applying a resin coating on a surface of the metal foil having a design heat-bonded under pressure.

11. A method for producing a decorative pattern according to claim 9, further comprising the steps of:
transferring the decorative pattern, in an aligned and temporarily-bonded state on a support, to an application tape having an adhesive layer; and
forming a fixing layer for the decorative pattern on an exposed face of the decorative pattern.

12. A method for producing a decorative plate according to claim 11, further including the steps of filling the decorative pattern to a concave portion of an adherend, said concave portion having substantially the same shape as that of the decorative pattern and, then, peeling the application tape from the decorative pattern.

13. The decorative pattern according to claim 2, wherein the metal foil having a design is a hologram foil or an electron beam designed foil.

14. The decorative pattern according to claim 3, wherein the metal foil having a design is a hologram foil or an electron beam designed foil.

15. The decorative pattern according to claim 2, wherein a resin coating is provided on a surface of the metal foil having a design.

16. The decorative pattern according to claim 3, wherein a resin coating is provided on a surface of the metal foil having a design.

17. The decorative pattern according to claim 4, wherein a resin coating is provided on a surface of the metal foil having a design.

18. The decorative pattern according to claim 2, wherein the metal pattern is an electroformed pattern.

19. The decorative pattern according to claim 3, wherein the metal pattern is an electroformed pattern.

20. The decorative pattern according to claim 2, wherein the metal pattern is an etched metal pattern.
